(19) United States
(12) Patent Application Publication
(10) Pub. No.: US 2014/0342625 A1
(43) Pub. Date: Nov. 20, 2014

(54) Curable Silicone Composition, Cured Material, Manufactured Articles, Methods And Uses

(71) Applicant: Dow Coming Corporation, Midland, MI (US)

(72) Inventors: Gary Wayne Murray, Kernersville, NC (US); Fernando Vazquez-Carrillo, Summerfield, NC (US)

(73) Assignee: Dow Corning Corporation, Midland, MI (US)

(21) Appl. No.: 14/362,610

(22) PCT Filed: Dec. 4, 2012
(86) PCT No.: PCT/US2012/067720

§ 371 Date: Jun. 4, 2014

Related U.S. Application Data
(60) Provisional application No. 61/567,160, filed on Dec. 6, 2011.

(51) Int. Cl. C08G 18/38; C08K 3/20; C09D 183/14; C08G 77/54

(52) U.S. Cl. CPC C08G 18/3893; C08G 77/54; C08K 3/20; C09D 183/14
USPC 442/81; 428/447; 528/28; 524/838

(57) ABSTRACT

A curable siloxane composition, cured material prepared therefrom, manufactured article prepared therewith, methods of making, and uses thereof, are disclosed. The composition comprises a mixture of ingredients (A) and (B): (A) a curable amount of a reactive group-functional siloxane, which has on average per molecule at least one curing-reactive group; and (B) an effective amount of an isocyanate or an isocyanate donor agent. The isocyanate has an average of at least one —N═C═O moiety per molecule thereof. The isocyanate donor agent produces an isocyanate when the isocyanate donor agent is exposed to a triggering condition.

This invention comprises silicone compositions, articles, preparations and uses.

Water repellent formulations generally have been used in a variety of coating and sealing applications in the construction, paper, textile, and wood industries. For example, see WO 1999/014422; U.S. Pat. No. 3,511,699; U.S. Pat. No. 4,847,310; U.S. Pat. No. 5,068,295; and U.S. Pat. No. 6,515,094 B2.

### BRIEF SUMMARY OF THE INVENTION

This invention comprises curable silicone compositions, cured materials, articles, preparations and uses. Embodiments of the invention include:

A curable siloxane composition comprising a mixture of ingredients (A) and (B): (A) a curable amount of a reactive group-functional siloxane, which has on average per molecule at least one curing-reactive group (CRG); (B) an effective amount of an isocyanate or an isocyanate donor agent, wherein the isocyanate has an average of at least one —N═C═O moiety per molecule thereof and wherein the isocyanate donor agent is characterizable as producing an isocyanate when the isocyanate donor agent is exposed to a triggering condition.

A method of making the composition, the method comprising combining ingredients (A) and (B) together under conditions effective therefor so as to give the composition.

A cured material prepared by curing the composition.

A manufactured article comprising a substrate and the composition or the cured material in operative contact therewith.

The composition is curable and the composition and cured material are useful, inter alia, as a coating, filler, film, sealant, or other treatment.

### DETAILED DESCRIPTION OF THE INVENTION

The Brief Summary and Abstract are incorporated here by reference. The curable silicone compositions, cured materials, articles, and preparations are especially useful for water repellent applications. For example, the composition and cured material are especially useful, inter alia, as a water repellant coating, water repellant filler, water repellant film, water repellant sealant, or other water repellant treatment. The curable silicone compositions, cured materials, articles, and preparations are especially useful in the construction, paper, textile, and wood industries. Some embodiments of the invention may be described or illustrated with reference to a manufactured article comprising a fabric, but the invention is not limited to fabrics or related manufactured articles. As described or illustrated later, the invention also contemplates manufactured articles other than fabrics.

This invention solves some of the problems discovered for prior art water repellent compositions that lack durability or contain undesirable ingredients. For example, paper, textile, or wood may be treated with a basic prior art composition to render the treated material moisture repellent. Lacking durability, however, such treated materials disadvantageously loose water repellency function upon repeated washing, eventually rendering them less suitable or unsuitable for their intended uses. A fluorocarbon may be included in prior art compositions (e.g., WO 1999/014422) to improve water repellency or durability thereof, but fluorocarbons may impart a harsh “hand” or “feel” and are expensive. A solution of the present invention comprises an alternative curable composition and cured material with improved water repellency durability after repeated washing without needing a fluorocarbon. Thus, the curable composition and cured material may lack any and all fluorocarbon, and yet still have the improved water repellency durability and may have a soft feel. Certain aspects of this invention may independently solve additional problems and/or have other advantages.

Ingredient (A), the reactive group-functional siloxane, may be an amino-functional siloxane, epoxy-functional siloxane, a hydroxyl-functional siloxane, a Si(alkyl,H)-functional siloxane, or a combination of the hydroxyl-functional siloxane and either the epoxy-functional or Si(alkyl,H)-functional siloxane. The amino-functional siloxane may be an amino-functional silsesquioxane (siloxane comprising T units), alternatively an aminoethyl/aminopropyl-silsesquioxane (siloxane comprising T units and amino-functional CRG comprising aminoethyl and aminopropyl groups), alternatively a hydroxyl-terminated aminoethyl/aminopropyl-silsesquioxane. Alternatively, ingredient (A) is the epoxy-functional siloxane or Si(alkyl,H)-functional siloxane. Alternatively, ingredient (A) is the epoxy-functional siloxane; alternatively the combination of the epoxy- and hydroxyl-functional siloxanes; alternatively the combination of the epoxy-functional and Si(alkyl,H)-functional siloxanes. Alternatively, ingredient (A) is a combination of the hydroxyl- and amino-functional siloxanes. The epoxy-functional siloxane has an average of at least one oxiranyl moiety (a radical 3-membered ring of formula C₂H₃O) per molecule thereof. Likewise, the amino-functional, hydroxyl-functional, and Si(alkyl,H)-functional siloxanes may have an average of at least one —NH₂, —OH, or Si(alkyl,H), respectively, per molecule thereof. Ingredient (A) may lack: a fluoro-containing siloxane, alternatively a sulfur-functional siloxane, alternatively an alkenyl-functional siloxane (e.g., vinyl), alternatively sulfur- and alkenyl-functional siloxanes, alternatively each of fluoro-, sulfur-, and alkenyl-functional siloxanes, alternatively any siloxane other than ingredient (A).

The reactive group-functional siloxane comprises a backbone siloxane portion and curing-reactive groups (CRGs) bonded thereto. The backbone siloxane may be any M, D, T, or Q molecule or covalent combination (e.g., MDM molecule) or mixture (blend) of such molecules (e.g., MDM and DT). Known symbols M, D, T, and Q, represent the different functionality of structural units that may be present in a siloxane (i.e., silicone), which comprises siloxane units joined by covalent bonds. The monofunctional (M) unit represents R₃SiO_{1/2}; the difunctional (D) unit represents R₂SiO_{2/2}; the trifunctional (T) unit represents RSiO_{3/2} and results in the formation of branched linear siloxanes; and the tetrafunctional (Q) unit represents SiO_{4/2} and results in the formation of crosslinked and resinous compositions. The reactive group-functional siloxane may be RSiO_{3/2} units (i.e., T units) and/or SiO_{4/2} units (i.e., Q units) in covalent combination with RR₂SiO_{1/2} units (i.e., M units) and/or R₂SiO_{2/2} units (i.e., D units). The covalent combination may be a DT resin, an MT resin, an MDT resin, a DTQ resin, and MTQ resin, and MDTQ resin, a DQ resin, an MQ resin, a DTQ resin, an MTQ resin, or an MDQ resin. Each R typically is an organogroup. The organogroup independently may be a hydrocarbyl, e.g., an alkyl, alkenyl, alkynyl, cycloalkyl, aryl, or a combination thereof (e.g., alkylphenyl or phenylalkyl, e.g., benzyl). Each hydrocarbyl independently may have from 1 to 20, alternatively from 1 to 10, alternatively from 1 to 7, alternatively from 1 to 4 carbon atoms. Each hydrocarbyl independently may be unsubstituted or substituted with at least 1 substituent. Each substituent independently may be halo (e.g., fluoro, chloro, bromo, or iodo); or unsubstituted (C₁-C₅)alkyl, (C₁-C₅)alkoxy (i.e., (C₁-C₅)alkyl)O—), (C₁-C₅)alkanoyl, or ((C₁-C₅)alkyl)₂N—. Some R may be or contain at least one CRG, alternatively all R may lack CRGs.

The curing-reactive group(s) (CRGs) may be at least one group reactive with an isocyanate moiety, alternatively at least one group reactive with a blocked isocyanate moiety, alternatively at least one group (e.g., epoxy) reactive with a cellulosic moiety (e.g., C—OH), alternatively at least two groups that are reactive with each other, alternatively a combination thereof. The reactive group-functional siloxane has an average per molecule of at least one, alternatively at least two, alternatively>2, alternatively at least 3 CRGs. CRGs can be cured in presence of the other ingredients to give a cured material. Each CRG independently may be covalently bonded to terminal or interior carbon atom (e.g., as in a carbon atom of the R group) or a silicon atom of the backbone siloxane. Examples of such isocyanate-reactive groups are hydroxyl (—OH), primary amino (—NH₂ wherein the N is bonded to an aliphatic carbon atom other than a carbonyl carbon, e.g., a saturated or aromatic aliphatic carbon atom), secondary amino (—N(H)-aliphatic wherein the N is bonded to another aliphatic carbon atom other than a carbonyl carbon, e.g., a saturated or aromatic aliphatic carbon atom), or Si(alkyl)-H. The hydroxyl, primary amino, or secondary amino may also be reactive with the blocked isocyanate. Each alkyl of the Si(alkyl,H) independently may have from 1 to 4, alternatively from 1 to 3, alternatively 1 or 2, alternatively 1 carbon atoms, e.g., Si(methyl,H). Reaction of CRGs may be initiated by a trigger condition (e.g., heat), another ingredient, or some other trigger agent. Once initiated, the reaction may thereafter self-propagate. For example during curing the epoxy functional siloxane, water (e.g., ingredient (D)) if present may also function as a curing reaction initiator by ring opening an oxiranyl moiety of a first molecule of the epoxy functional siloxane to give a 1,2-diol, one —OH of which may then condense with an oxiranyl moiety of a second molecule of the epoxy-functional siloxane, thereby crosslinking the first and second molecules, and so on. Alternatively or additionally, the 1,2-diol may react with the isocyanate or blocked isocyanate moiety to give a carbamate crosslink.

Ingredient (A) may be prepared by synthetic chemistry or obtained from a commercial supplier. Patents U.S. Pat. No. 4,087,585; U.S. Pat. No. 5,194,649; U.S. Pat. No. 5,248,715; U.S. Pat. No. 5,614,640; U.S. Pat. No. 5,744,507; and U.S. Pat. No. 7,521,124 B2 mention suitable epoxy-functional siloxanes and their preparation. For example, some epoxy-functional siloxanes may be prepared by condensation of a hydroxyl-terminated polyorganosiloxane with an epoxy-functional alkoxysilane as described in U.S. Pat. No. 7,521,124 B2. Examples of suitable epoxy-functional alkoxysilanes are 3-glycidoxypropyltrimethoxysilane, 3-glycidoxypropyltriethoxysilane, (epoxycyclohexyl)ethyldimethoxysilane, (epoxycyclohexyl)ethyldiethoxysilane and combinations thereof. Examples of suitable unsaturated alkoxysilanes include vinyltrimethoxysilane, allyltrimethoxysilane, allyltriethoxysilane, hexenyltrimethoxysilane, undecylenyltrimethoxysilane, 3-methacryloyloxypropyl trimethoxysilane, 3-methacryloyloxypropyl triethoxysilane, 3-acryloyloxypropyl trimethoxysilane, 3-acryloyloxypropyl triethoxysilane, and combinations thereof. A suitable commercially available epoxy-functional siloxane is an aqueous emulsion having 40 wt % cyclohexyl epoxy-functional siloxane (siloxane containing a bicyclic radical of formula C₆H₉O) and a nonionic surfactant (Dow Corning Corporation, Midland, Mich., USA). Ingredient (A) may be used in the composition in an amount ranging from 0.1 wt % to 10 wt %, alternatively from 0.5 wt % to 7 wt %, alternatively from 0.9 wt % to 6 wt %, alternatively from 1.0 wt % to 3 wt %, alternatively from 1.1 wt % to 2.5 wt %, alternatively any combination of the foregoing lower and upper limits.

Ingredient (B), the isocyanate or isocyanate donor agent, may be the isocyanate, alternatively the isocyanate donor agent. “Isocyanate” and “polyisocyanate” each may be a molecule that is a polymer (e.g., comprised of at least 5 repeat units), alternatively oligomer (e.g., comprised of from 2 to 4 repeat units), alternatively a monomer (lacking a repeat unit). Ingredient (B) may be in form of a liquid, alternatively a finely divided solid, alternatively a solution, dispersion, or emulsion in ingredient (D). When the composition comprises ingredient (D) and ingredient (D) is water, the isocyanate donor agent may be the monomeric molecule; and when ingredient (D) is an aprotic organic vehicle, the isocyanate or isocyanate donor agent may be the oligomeric or polymeric molecule. The isocyanate moiety is —N═C═O. The isocyanate may be a monoisocyanate having an average of 1 isocyanate moiety per molecule thereof, alternatively a polyisocyanate having an average of at least 2 isocyanate moieties per molecule thereof.

The isocyanate may be an aliphatic or aromatic isocyanate. The aliphatic isocyanate may be an acyclic or alicyclic isocyanate. The aromatic isocyanate may contain a (C₆-C₁₀)aromatic group (e.g., phenyl, phenylene, or benzene-triradical, or naphthalene group). Examples of suitable monomeric isocyanates are those having a molecular weight of from 168 to 300 g/mol. Some suitable monoisocyanates are phenylisocyanate, benzylisocyanate, tolylisocyanate, methylisocyanate, and cyclohexylisocyanate. The polyisocyanate may be a diisocyanate, triisocyanate, or mixture thereof. The polyisocyanate may be a tolylene diisocyanate (i.e., toluene diisocyanate (TDI)), or a mixture of regioisomers thereof. Some suitable polyisocyanates are those having aliphatically bound isocyanate groups such as 1,6-hexamethylene diisocyanate (HDI), 2,2,4- and/or 2,4,4-trimethyl-1,6-hexamethylene diisocyanate (TMDI), dodecamethylene diisocyanate, cyclohexane-1,3-and-1,4-diisocyanate, 1-isocyanato-2-isocyanatomethyl cyclopentane, 1-isocyanato-3-isocyanato-methyl-3,5,5-trimethylcyclohexane (isophorone diisocyanate or IPDI), bis-(4-isocyanatocyclohexyl)-methane (HMDI), 1,3- and 1,4-bis-(isocyanatomethyl)-cyclohexane, bis-(4-isocyanato-3-methylcyclohexyl)-methane, xylylene diisocyanate, α,α,.alpha.′,α′-tetramethyl-1,3- and/or -1,4-xylylene diisocyanate, 1-isocyanato-1-methyl-4(3)-isocyanatomethyl cyclohexane, and 2,4- and/or 2,6-hexahydrotoluoylene diisocyanate. Examples of suitable blocked isocyanates are oximo-blocked versions (e.g., a dialkyloximo such as methyl ethyl oximo) of the immediately foregoing isocyanates. Examples of suitable commercial blocked isocyanates are oxime-blocked isocyanates sold as DESMODUR L 75 (a polymeric isocyanate obtained by reaction of a tolylene diisocyanate with 1,1,1-trimethylolpropane and dimethylene glycol and that comprises an average of at least 2-N═C═O moieties per molecule; from Bayer, Germany); DDI 1410-Diisocyanat (a cyclohexane substituted with a plurality of alkyl groups, two of which are 2 O═C═N-alkylene moieties; from Cognis, USA); PHOBOL XAN (aqueous dispersion, Huntsman Corporation, Salt Lake City, Utah, USA); NK ASSIST V-2 (aqueous dispersion, NICCA U.S.A., Inc., Fountain Inn, S.C., USA); and VESTANAT IPDI, VESTANAT TMDI, and VESTANAT B 370 (all of Degussa-Hüls, Germany).

The isocyanate donor agent may be any compound that produces a molecule having an average of at least one isocyanate moiety, alternatively at least two isocyanate moieties, when the isocyanate donor agent is exposed to the triggering condition. The isocyanate donor agent may lack an isocyanate moiety, but converts to the molecule having an average of at least one, alternatively at least two isocyanate moieties as a result of an effect of the triggering condition. The isocyanate donor agent may produce the one or more isocyanate moieties during or after occurrence of the triggering condition. The molecule may be the isocyanate. Before the isocyanate donor agent experiences the triggering condition, it may be characterizable as having capacity to produce the isocyanate. The isocyanate donor agent typically is a blocked isocyanate, which may be a blocked monoisocyanate, alternatively a blocked polyisocyanate. One average per molecule, the blocked monoisocyanate has one, and the blocked polyisocyanate has at least two groups of formula R^{B}—C(O)N(H)—, wherein each R^{B} independently is a releasable blocking group such that when a molecule of the blocked isocyanate is exposed to the triggering condition each blocked isocyanate moiety thereof donates or produces an isocyanate moiety and releases a formally neutral compound or a formally anionic compound, which may be protonated to give a compound of formula R^{B}—H. The neutral compound may be an alkali metal bisulfite (e.g., sodium or potassium bisulfite). The isocyanate donor agent may be a blocked isocyanate compound of formula (B): (R^{B}—C(O)NH)_{X}R^{X} (B), wherein x is an integer of at least 1; R^{X} is a monoradical or polyradical of an aliphatic or aromatic compound, wherein there are x radicals in the polyradical (e.g., when x=1, R^{X} is the monoradical, when x=2, R^{X} is a diradical, when x=3, R^{X} is a triradical, and so on). The x may be 1, alternatively 2, alternatively 3, alternatively at most 6, alternatively at most 4. The R^{X} may be the aliphatic compound, alternatively the aromatic compound. The aliphatic compound may be an acyclic or alicyclic compound. R^{B} is a releasable blocking group such that when the isocyanate donor agent is exposed to the triggering condition, the isocyanate donor agent formally produces the isocyanate as a compound of formula (I): (O═C═N)_{X}R^{X} (I) and a blocking compound of formula R^{B}—H, wherein x, R^{X}, and R^{B} are as defined above. The blocked isocyanate may be triggered to produce the isocyanate and ad rem mole equivalents of the blocking compound R^{B}—H at temperature called herein the unblocking temperature, e.g., from 140 degrees Celsius (° C.) to 200° C.

While R^{B} may be formally released as a monoanion from compound (B), in the compound of formula R^{B}—H, R^{B} formally may be a monoradical of an active hydrogen compound (e.g., monoradical of phenol (PhO radical), phthalimide, or dimethyl malonate). Alternatively, R^{B} may be a monoradical: (a) an N- or O-monoradical of a lactam; (b) a N-monoradical of a ring N(H)-containing heteroarene; (c) an O-monoradical of the oxime of formula (O): H—O—N═CR¹R² (O), wherein R¹ is hydrocarbyl, heterohydrocarbyl, or organoheteryl and R² is H, hydrocarbyl, heterohydrocarbyl, or organoheteryl; or wherein R¹ and R² are taken together to form a hydrocarbylene, heterohydrocarbylene, or organoheterylene; or (d) any combination of at least two of (a) to (c). The lactam may be ε-caprolactam, δ-valerolactam, γ-butyrolactam, or a mixture thereof. The ring N(H)-containing heteroarene may be a pyrrole; a pyrazole (e.g., a dimethylpyrazole, e.g., 3,5-dimethylpyrazole); an imidazole; a triazole; a tetrazole, or a mixture of at least two thereof. In the oxime of formula (O), each of R¹ and R² independently may be alkyl, cycloalkyl, or phenyl; or R¹ and R² are taken together to form an alkylene. Examples of oximes of formula (O) are the reaction products of reactions of hydroxylamine (H₂NOH) and ketones that lack groups that react with isocyanate moieties (e.g., lack —NH₂ and —OH). The ketone may have aliphatic, aromatic, or both moieties and may have from 3 to 12 carbon atoms. Examples of oximes of formula (O) are acetaldoxime, methyl ethyl ketone oxime, methyl isobutyl ketone oxime, cyclohexanone oxime, acetophenone oxime, benzophenone oxime, methylglyoxal oxime, and ethylglyoxal oxime.

The ingredient (B) functions in the composition to, inter alia, enhance the water repellency function, including durability thereof, of the cured material and/or the manufactured article comprising the cured material. To be clear and avoid misinterpretation, unreacted ingredient (B) does not have to remain after the curing, or be present in the cured material or manufactured article, for the ingredient (B) to be ultimately responsible for the enhanced water repellency function of the cured material and the manufactured article. For example, the enhanced water repellency function of the cured material and the manufactured article may be due to the presence of a reaction product in the cured material and manufactured article, wherein the reaction product is produced by a reaction involving ingredient (B) as a reactant. The reaction product may be produced during the curing by a reaction of ingredients comprising ingredients (A) and (B), alternatively a reaction of ingredients comprising ingredients (A) and (B) and the substrate. Therefore, in some embodiments molecules of ingredient (B) are absent from the cured material and manufactured article, and yet the cured material and manufactured article are characterizable by the enhanced water repellency function. It is convenient to refer to the quantity of ingredient (B) in the composition that produces the enhanced water repellency function of the cured material and the manufactured article as the enhancing effective amount, or simply effective amount, of ingredient (B). Ingredient (B) may be used in the composition in an effective amount ranging from 0.1 wt % to 10 wt %, alternatively from 0.5 wt % to 7 wt %, alternatively from 1.0 wt % to 6 wt %, alternatively from 1.1 wt % to 3 wt %, alternatively from 1.5 wt % to 2.5 wt %, alternatively any combination of the foregoing lower and upper limits.

Ingredient (B) may be prepared by synthetic chemistry or obtained from a commercial supplier. Patents U.S. Pat. No. 4,098,933; U.S. Pat. No. 4,284,544; U.S. Pat. No. 4,522,851; and U.S. Pat. No. 4,895,921 mention suitable isocyanates or blocked isocyanates, including water soluble blocked isocyanates, and their preparations. The blocked isocyanate may normally be formed from a corresponding isocyanate (—N═C═O) and a blocking agent R^{B}—H, wherein R^{B} is as defined previously. For example, blocked (poly)isocyanates may be prepared by reacting the (poly)isocyanates with sufficient mole equivalents of the blocking agent R^{B}—H under carbamate- or urea-forming conditions. For example, a ketone of formula R¹R²C═O may be allowed to react with hydroxylamine to give the ketone-derived oxime of formula R¹R²C═N—OH, which in turn may be allowed to react with a (poly)isocyanate of formula (O═C═N)_{X}R^{X} to prepare a blocked isocyanate of formula (B^{O}) (R¹R²C═N—O—C(O)NH)_{X}R^{X} (B^{O}), wherein x, R^{X}, R¹ and R² are as defined previously. The blocking reaction may be done neat or in an aprotic solvent (e.g., diglyme). The blocked isocyanate may be formed at a moderate condensation temperature, e.g., from 20° C. to 120° C. Infrared spectroscopy may be used to determine that the —N═C═O moieties are blocked. The isocyanate used to form the blocked isocyanate and the isocyanate produced by the blocked isocyanate in response to the triggering condition may be the same as each other. Alternatively, they may be different than each other in circumstances where not all blocked isocyanate moieties become unblocked or some isocyanate moieties subsequently are hydrolyzed to a corresponding amine and CO₂ gas.

Each molecule of ingredients (A) and (B) independently may be unsubstituted, alternatively substituted. Each substituent in the substituted molecule formally replaces a different hydrogen atom of the unsubstituted molecule. The substituted molecule has at least one substituent, alternatively at least 2, alternatively at most 6, alternatively at most 4, alternatively at most 3 substituents. Each unsubstituted molecule and each substituent independently may have at most 40, alternatively at most 30, alternatively at most 20, alternatively at most 10, alternatively at most 7, alternatively at most 5, alternatively at most 3, alternatively at most 2, alternatively 1 carbon atom. The substituents may replace hydrogen atoms in at least one of the following groups: the releasable blocking group RB, N-monoradical of heteroarene, hydrocarbyl, heterohydrocarbyl, organoheteryl, hydrocarbylene, heterohydrocarbylene, organoheterylene, N- or O-monoradical of lactam, alkyl, cycloalkyl, phenyl, and alkylene. Each substituent independently may be a halo (e.g., fluoro, chloro, bromo, or iodo), an alkyl (e.g., methyl or ethyl), cycloalkyl (e.g., cyclopentyl), phenyl, alkylphenyl (e.g., tolyl), phenyl-alkyl (e.g., benzyl), or alkoxy (e.g., methoxy).

In some embodiments the composition further comprises at least one additional ingredient that is distinct from ingredients (A) and (B). The distinction may be of structure, function, or feature (e.g., color). For example, some embodiments of the composition may further comprise an effective amount of a cure agent, vehicle (e.g., dispersant or solvent), surfactant, fabric dye, or other ingredient as described herein. Alternatively, the composition may further comprise at least one of ingredients (C) to (V): (C) a curing effective amount of a cure agent; (D) a dispersing effective amount of a vehicle suitable for use with ingredients (A) and (B); (E) an effective amount of a surfactant for emulsifying the reactive group-functional siloxane in water; (F) a fabric modifier such as (f1) a fabric softener or (f2) a fabric finishing agent or (f3) fabric dye; (G) an optical brightener; (H) a lubricant; (I) an extender, a plasticizer, or a combination thereof; (K) a wrinkle-removing agent; (L) a flame retardant; (M) a biocide, such as (m1) a fungicide, (m2) an herbicide, (m3) a pesticide, or (m4) an antimicrobial; (N) a chain lengthener; (O) a curing reaction initiator; (P) an isocyanate donor triggering agent (e.g., to trigger moisture curing of the composition); and (Q) a combination thereof (e.g., a combination of any two or more of ingredients (D) to (Q)). In some embodiments at least one, alternatively each of additional ingredients (C) to (Q) does not completely prevent the reaction curing or of the composition or water repellency of the cured material. The additional ingredients (C) to (Q) are optional, are each independently present in or absent from the composition, and are distinct from one another and from ingredients (A) to (B) and are generally compatible with reaction curing of silicone compositions. There may be overlap between types or functions of ingredients because certain ingredients described herein may have more than one function. Amounts of ingredients (C) to (E), when present, may be as described later and amounts of ingredients (F) to (Q), when present, may be chosen and varied under the circumstances, and typically independently may be from 1 to 20 wt % of the relevant composition.

Ingredient (C), the cure agent, is optional and may be used when an enhanced degree or rate of curing is desired. For example, if the CRG of the reactive group-functional siloxane is other than amino and an increased speed or lower temperature of curing of the composition to the cured material is desired, the composition may further comprise the ingredient (C) the curing effective amount of a cure agent. The cure agent is effective for facilitating curing of ingredient (A) (especially, the epoxy-, hydroxyl-, Si(alkyl,H)-functional siloxane, or the combination of the epoxy-functional and Si(alkyl,H)-functional siloxane) under the curing conditions. The cure agent may be a substance that promotes a condensation reaction of ingredients (A) and (B) during the method. Ingredient (C) may be a cure catalyst or may facilitate curing without true catalysis (e.g., ingredient (C) may be a compound that reacts with anionic form of R^{B}). The cure agent may be any suitable substance that is effective for promoting curing of the composition (e.g., increasing cure speed). Ingredient (C) may be absent (e.g., when ingredient (A) is amino-functional siloxane); alternatively ingredient (C) may be present, particularly when ingredient (A) is other than amino-functional siloxane. The cure agent can be employed in the composition in any curing effective amount, which typically may be from ≧0.01 to 20 wt %, alternatively from ≧0.1 to 15 wt %, alternatively from ≧1 to 10 wt %, alternatively in this range a minimum≧0.20 wt %, alternatively ≧0.30 wt %, alternatively ≧0.50 wt %; and alternatively in this range a maximum≦4 wt %, alternatively ≦3 wt %, alternatively ≦2 wt %, alternatively ≦1 wt %; alternatively any combination of upper and lower limits thereof. The cure agent may comprise a transition metal or salt thereof, a protic acid, or a combination thereof. The protic acid may be used as a cure catalyst with any of the reactive group-functional siloxanes, especially the epoxy-functional siloxane. The transition metal or salt thereof may be used with any of the reactive group-functional siloxanes. Examples of suitable ingredient (C) for use with the amino-functional siloxane are amine-modified titanates. Examples of suitable ingredient (C) for use with the Si(alkyl,H)-functional siloxane and epoxy-functional siloxane are organotin compounds, zinc acetate, zinc bis(tetrafluoroborate), zirconium acetate, amine-modified titanate, the protic acid, or a combination of at least two thereof (e.g., zinc acetate plus amine-modified titanate with the Si(alkyl,H)-functional siloxane). The protic acid may be a dihydrogenphosphate monobasic salt or a carboxylic acid. The dihydrogenphosphate monobasic salt may be an ammonium dihydrogenphosphate, sodium dihydrogenphosphate, or potassium dihydrogenphosphate. The carboxylic acid may be a (C₁-C₆)carboxylic acid such as a (C₁-C₆)monocarboxylic acid (e.g., formic acid, acetic acid, or hexanoic acid), alternatively (C₂-C₆)dicarboxylic acid (e.g., oxalic acid, malonic acid, or succinic acid), alternatively a (C₃-C₆)tricarboxylic acid (e.g., citric acid). Suitable cure agents are commercially available (e.g., from Sigma-Aldrich Company, St. Louis, Mo.; Momentive, Columbus, Ohio; or Gelest, Inc., Morrisville, Pa., all of USA) or can be readily prepared by methods known in the art.

Ingredient (D), the dispersing vehicle, is optional and may be, e.g., a solvent and/or diluent. Ingredient (D) is a dispersing effective amount of the dispersing vehicle, which is suitable for (dispersing) ingredients (A) and (B) and any other ingredients in the composition. The dispersing vehicle may support formation, stability, or formation and stability of a dispersion of ingredients (A) and/or (B), and optionally any other ingredient, in the dispersing vehicle. Each of the ingredients (A), (B), and any other ones independently may be dissolved, alternatively suspended, alternatively partially dissolved/partially suspended in ingredient (D). Ingredient (D) facilitates easy mixing of ingredients (A) and (B), alternatively (A)-(C), alternatively (A)-(C) and (E), and the resulting emulsion/dispersion facilitates easy contacting of an exposed surface of a fabric in need of water repellent treatment with a water-repelling effective amount of the composition, whereafter curing the contacted composition gives a treated surface of the fabric. The curing may be preceded by removing the ingredient (D), e.g., by evaporation. The dispersing vehicle may be an aprotic organic vehicle, alternatively water. The isocyanate donor agent may be used with water. The isocyanate may be used with the aprotic organic vehicle. The aprotic organic vehicle may be an organic solvent, including an organic solvent having a boiling point at 101 kilopascals (kPa) of from 20° C. to 150° C. The organic solvent may be a ketone such as acetone, methylethyl ketone, or methyl isobutyl ketone; a hydrocarbon such as an aromatic hydrocarbon such as benzene, toluene, or xylene; or an aliphatic hydrocarbon such as heptane, hexane, or octane; an ether or polyether such as tetrahydrofuran or diglyme; a carboxylic ester such as ethyl acetate; a halogenated hydrocarbon such as chloroform, dichloromethane, 1,1,1-trichloroethane or methylene chloride; dimethyl sulfoxide; dimethyl formamide, acetonitrile; white spirits; mineral spirits; naphtha; n-methylpyrrolidone; or a combination thereof. The amount of ingredient (D) can depend on various factors including the type of dispersing vehicle selected and the amount and type of other ingredients selected for the composition. However when present, ingredient (D) may range from 1 to 99.9 wt %, alternatively from 5 to 95 wt % of the composition. The composition comprising ingredients (A) to (D) may contain concentrations thereof wherein: ingredient (A) is from 0.1 to 99 wt %, ingredient (B) is from 0.1 to 99 wt %, ingredient (C) is from 0.01 to 20 wt %, and ingredient (D) is from 1 to 99.9 wt %, and the sum of the concentrations of ingredients (A) to (D) is at most 100 wt %.

Ingredient (E), the surfactant, is optional and may be, e.g., a nonionic, alternatively an ionic surfactant. The ionic surfactant may be anionic, alternatively cationic. The surfactant may be cationic, alternatively nonionic. The cationic surfactant may be, e.g., a combination of hexadecyltrimethylammonium chloride and polyoxyethylene (12) tridecyl ether; or a combination of trimethyltallowalkylammonium chloride and ethoxylated linear alcohols. The nonionic surfactant may be, for example, cetostearyl alcohol, cetyl alcohol, cocamide DEA, glycerol laurate, nonoxynols, oleyl alcohol, pentaethylene glycol monododecyl ether, polysorbate, stearyl alcohol, and Tween 80. Ingredient (E) is an emulsifying effective amount of the surfactant, which is suitable for (emulsifying) at least ingredient (A) in the composition. The surfactant may support formation, stability, or formation and stability of an emulsion comprising ingredient (A) (e.g., an epoxy-functional siloxane) in water, alternatively an emulsion comprising ingredients (A) and (B) in water, alternatively an emulsion comprising ingredients (A)-(C) in water. Ingredient (E) facilitates easy mixing of ingredients (A)-(D) and the resulting emulsion/dispersion facilitates easy contacting of an exposed surface of a fabric in need of water repellent treatment with a water-repelling effective amount of the composition, whereafter curing the contacted composition gives a treated surface of the fabric. The ingredient (E) may be used with the reactive group-functional siloxane, alternatively with the reactive group-functional siloxane and water. The amount of ingredient (E) can depend on various factors including the type of surfactant selected and the amount and type of other ingredients selected for the composition. However when present, ingredient (E) may range from 0.01 to 20 wt %, alternatively from 0.1 to 10 wt %, alternatively from 1 wt % to 5 wt %, of the composition. The composition comprising ingredients (A) to (E) may contain concentrations thereof wherein: ingredient (A) is from 0.1 to 99 wt %, ingredient (B) is from 0.1 to 99 wt %, ingredient (C) is from 0.01 to 20 wt %, ingredient (D) is from 1 to 99.9 wt %, and ingredient (E) is from 0.01 to 20 wt %, and the sum of the concentrations of ingredients (A) to (E) is at most 100 wt %.

Concentrations of ingredients (A) to (C) and (E) to (P) in the composition may vary depending on whether or not ingredient (D) is present and, if present, how much of ingredient (D) is present. For example, a “concentrated” embodiment of the composition comprising, alternatively consisting essentially of, alternatively consisting of ingredients (A) to (D), alternatively ingredients (A) to (E), may be prepared wherein the concentration of ingredient (D) (e.g., water) is at a lower portion of the range from 1 to 99.9 wt %, such as from 1 to 50 wt %, alternatively from 1 to 30 wt %, alternatively from 1 to 20 wt %. The concentrated composition (a “concentrate”) may be used directly in a fabric finishing operation and may be relatively more economical to make and transport. Optionally, before use in a fabric finishing operation, the “concentrated” composition may be diluted with an amount of a different, alternatively same ingredient (D) to give a “diluted” embodiment of the composition wherein the concentration of ingredient (D) is at an upper portion of the range 1 to 99.9 wt %, such as from 51 to 99.9 wt %, alternatively from 70 to 99.9 wt %, alternatively from 90 to 99.9 wt %. The variation in wt % of ingredients (A) to (C) and (E) to (P) in relation to ingredient (D) may be illustrated in the examples shown below in Table A for a neat mixture embodiment consisting (essentially of) ingredients (A) to (C), a concentrate embodiment consisting (essentially of) ingredients (A) to (E) (optionally prepared from the neat embodiment or separately), and a diluted embodiment (e.g., final bath for treating textile) consisting (essentially of) ingredients (A) to (E) (optionally prepared from the neat mixture, or concentrate or separately).

TABLE A

| | Concentration (wt %) | | |
|---|---|---|---|
| Ingredient | Neat | Concentrate | Diluted |
| (A) | 83 | 31 | 2.0 |
| (B) | 10 | 4 | 0.3 |
| (C) | 7 | 2 | 0.2 |
| (D) | 0 | 61 | 97.4 |
| (E) | 0 | 1 | 0.1 |
| Composition | 100 | 100 | 100 |

In view of the potential for variation of concentrations of some ingredients with amount of ingredient (D), it may be convenient to describe the composition by a weight/weight (wt/wt) ratio of ingredients (A)/(B), (A)/(C), (B)/(C), (E)/(A), or any combination of at least two thereof (i.e., and ignoring amounts/concentrations of any and all other ingredients). In the composition the relative amounts of ingredients (A)/(B) may be from 0.1 to 50 wt/wt, alternatively from 1 to 25 wt/wt, alternatively from 2 to 10 wt/wt, alternatively any combination of the foregoing lower and upper limits thereof. In the composition the relative amounts of ingredients (A)/(C) may be from 1 to 100 wt/wt, alternatively from 2 to 50 wt/wt, alternatively from 5 to 20 wt/wt, alternatively any combination of the foregoing lower and upper limits thereof. In the composition the relative amounts of ingredients (A)/(E) may be from 2 to 200 wt/wt, alternatively from 5 to 100 wt/wt, alternatively from 10 to 50 wt/wt, alternatively any combination of the foregoing lower and upper limits thereof.

The composition may comprise ingredients (A) and (B); alternatively ingredients (A) to (C); alternatively ingredients (A), (B), and (D); alternatively ingredients (A), (B), (D), and (E); alternatively ingredients (A) to (D); alternatively ingredients (A) to (E); alternatively any one of the immediately foregoing combinations of ingredients and further comprising another one ingredients (F) to (P), e.g., ingredient (O). The composition may consist essentially of ingredients (A) and (B), which means the composition lacks ingredient (C), alternatively lacks ingredients (C) and (D), alternatively lacks ingredients (C) to (E). Alternatively, the composition may consist essentially of (A) to (C), which means the composition lacks ingredient (D), alternatively lacks ingredients (D) and (E). For present purposes, “consist(ing) essentially of” means the composition has less than 5%, alternatively <2%, alternatively <1%, alternatively <0.10%, alternatively 0% of the aforementioned maximum wt % of the lacking ingredient(s). E.g., when consisting essentially of ingredients (A) and (B) means the composition lacks ingredient (C), such a composition has <1 wt % (0.05×20 wt %), alternatively <0.4 wt % (0.02×20 wt %), alternatively <0.2 wt % (0.01×20 wt %), alternatively <0.02 wt % (0.001×20 wt %), alternatively 0 wt % of ingredient (C).

The composition may be prepared by the method. The method comprises combining ingredients in any order, simultaneously, or any combination thereof unless otherwise noted herein. When the isocyanate donor agent is present, the combining may be performed under conditions that do not trigger conversion of the isocyanate donor agent to the isocyanate. In preparing the composition, ingredient (A) may be used neat; alternatively, when the composition includes ingredient (D), ingredient (A) may be used as a dispersion in at least some of the optional dispersing vehicle (ingredient (D), alternatively as an emulsion in at least some of the dispersing vehicle that contains a surfactant (ingredient (E)). The epoxy-functional siloxane may, alternatively may not crosslink with ingredient (B). When at least one of ingredients (A) and (B) is a solid, the combining may comprise mixing a suspension (e.g., when ingredient (A) is a liquid and ingredient (B) is a solid) or melt (e.g., when ingredient (A) and (B) are solids) of ingredients (A) and (B), wherein when ingredient (B) comprises the isocyanate donor agent and the isocyanate donor agent can be triggered to generate the isocyanate by heating the isocyanate donor agent at a trigger temperature, the temperature of the melt during the mixing is less than the trigger temperature. Wherein the curable siloxane composition comprises a mixture of the ingredients (A) to (D), the combining comprises mixing ingredients (A) to (D) together so as to give the mixture of the ingredients (A) to (D). Wherein the curable siloxane composition comprises a mixture of the ingredients (A) to (E); and wherein ingredient (B) is the isocyanate donor agent and the vehicle is water, the combining comprises mixing ingredients (A) to (E) together so as to give the mixture of the ingredients (A) to (E). The later combining step may comprise preparing a first dispersion or emulsion comprising ingredient (A), a portion of the water of ingredient (D), and, optionally, ingredient (E); preparing a second dispersion or emulsion comprising ingredient (B) in another portion of the water of ingredient (D); and mixing the first dispersion or emulsion and the second dispersion or emulsion together so as to give the mixture of the ingredients (A) to (E). The composition includes the embodiments thereof that are prepared by any of the aspects of the method.

Typically mechanics of the method comprises combining by contacting and mixing ingredients with equipment suitable for the mixing. The equipment is not specifically restricted and may be, e.g., agitated batch kettles for relatively high flowability (low dynamic viscosity) compositions, a ribbon blender, solution blender, co-kneader, twin-rotor mixer, Banbury-type mixer, or extruder. The method may employ continuous compounding equipment, e.g., extruders such as extruders, twin screw extruders (e.g., Baker Perkins sigma blade mixer or high shear Turello mixer), may be used for preparing compositions containing relatively high amounts of particulates. The composition may be prepared in batch, semi-batch, semi-continuous, or continuous process. General methods of combining are known, e.g., US 2009/0291238; US 2008/0300358.

The composition may be prepared as a one part or multiple part composition. The one-part composition may be prepared by combining all ingredients by any convenient means, such as mixing, e.g., as described for the method. All mixing steps or just a final mixing step may be performed under conditions that minimize or avoid curing. The composition may be stored in a container until ready for use. The multiple part (e.g., 2 part) composition may be prepared where at least one of ingredients (A) and (B) are stored in one part and ingredient (C) and, optionally the other of ingredients (A) and (B), is stored in a separate part, and the parts are combined (e.g., by mixing) shortly before use of the composition. Alternatively, the multiple part composition may comprise the first dispersion or emulsion as one part and the second dispersion or emulsion as the other part.

Once prepared the composition may be used immediately or stored for any practical period, e.g., ≧1 hour, alternatively ≧1 day, alternatively ≧1 week, alternatively 30 days, alternatively ≧300 days, alternatively ≧2 years before use. The composition may be stored in a container that protects the composition from exposure to curing conditions (e.g., heat). The storage may be at a suitable temperature (e.g., ≦40° C., e.g., 25° C.) and, if desired, under an inert gas atmosphere (e.g., N₂ or Ar gas). After such storage, the composition may, if desired, be cured directly, or first agitated and then cured, to give the cured material, which would exhibit the improved water repellency.

When desired, curing of the composition may be initiated by exposing it to the curing conditions to give the cured material. The curing conditions may comprise the triggering condition. The curing may be preceded by removing any volatile ingredient (e.g., boiling point<120° C. at 101 kilopascals) such as a volatile ingredient (D). Without being theory bound none, some, or all of the blocked isocyanate moieties may cure directly or first convert in situ to the isocyanate moiety during curing. When curing the composition ingredient (A) may form a noncovalent, alternatively covalent bond directly with the substrate. When the ingredient (B) has an average of at least two isocyanate moieties per molecule on the substrate, the ingredient (B) may covalently bond the substrate (e.g., cellulosic material) to the ingredient (A). The curing may provide the cured material in less than 2 hours, alternatively less than 1 hour, alternatively less than 10 minutes, alternatively less than 5 minutes, alternatively less than 3 minutes. The curing may be facilitated or accelerated by heating the composition with or without ingredient (C). When the composition comprises the isocyanate donor agent, the curing conditions comprise the triggering condition. The triggering condition is any means of or for causing donation or production of the isocyanate with an isocyanate moiety from the isocyanate donor agent. For example, the triggering condition may be heating the isocyanate donor agent and/or contacting the isocyanate donor agent with a catalyst to produce the isocyanate. The triggering condition may avoid oxidizing or reducing the isocyanate donor agent to give the isocyanate. Reiterated, the formal oxidation state of the blocked isocyanate moiety may be the same as the formal oxidation sate of the isocyanate moiety produced therefrom. When the isocyanate donor agent is the blocked isocyanate, the triggering condition may comprise heating the composition to an unblocking temperature. The unblocking temperature is any degree of hotness of the composition that is effective for causing donation or production of the isocyanate and release of the blocking compound (e.g., R^{B}—H) from the blocked isocyanate. The unblocking temperature may be from 140° C. to 200° C., e.g., from 150° C. to 170° C. (e.g., 160° C. or 170° C.). Depending on the particular ingredients of and concentrations in the composition, the unblocking temperature may provide the cured material in less than 10 minutes, alternatively less than 5 minutes, alternatively less than 3 minutes, alternatively less than or equal to 2 minutes. If desired, curing may be performed at higher or lower temperatures for shorter or longer periods of time. Upon curing, the resulting cured material may form a gum, gel, rubber, or resin. The cured material may comprise the released blocking compound (e.g., R^{B}—H). Alternatively, the blocking compound (e.g., R^{B}—H) may be removed from the curing composition or cured material by any suitable means such as by volatilization (e.g., when the blocking compound has a boiling point at 101 kPa of <150° C.), extraction with a solvent suitable for dissolving the blocking compound, or physical phase separation (e.g., squeezing or wiping). The cured material or manufactured article may have enhanced water repellency, e.g., increased initial water repellency or water repellency durability compared to non-invention cured material or manufactured article prepared by curing a comparative mixture that is otherwise the same as the composition except the comparative mixture lacks ingredient (B). E.g., the cured material may have enhanced durability of water repellency as measured by a Spray Rating when tested after 30 washing cycles (e.g., Home Laundering-Tumble Dry (HL-TD) Cycles) according to AATCC Test Method 22-2010 Water Repellency: Spray Test, promulgated by the American Association of Textile Chemists and Colorists, Research Triangle Park, North Carolina, USA.

The manufactured article may comprise a substrate and a water-repelling effective amount of the composition or the cured material in operative contact therewith. The manufactured article may comprise a water repellent fiber or fibrous substrate. The fibrous substrate may be a synthetic, alternatively natural material. The material may contain a plurality of —OH functional groups. The fibrous substrate may be a thread, yarn, or fabric. The fabric may comprise knitted or woven fiber yarns, or a nonwoven substrate. When the substrate is the woven fabric, the woven fabric may be a woven cotton fabric, e.g., a cotton twill fabric. As shown later in the Examples, the manufactured article may be a water repellent fabric that is characterizable as having a water repellency spray rating after 30 HL-TD cycles that is at least 5%, alternatively at least 10%, alternatively at least 25%, alternatively at least 40% higher, alternatively at least 50% higher than a water repellency spray rating after 30 HL-TD cycles for a comparative cured material prepared from a composition comprising ingredients (A) and (C) and lacking ingredient (B); alternatively (A), (C), and (D) and lacking ingredient (B); alternatively (A), (C), (D), and (E) and lacking ingredient (B). Each water repellency spray rating may be measured according to the AATCC Test Method 22-2010 Water Repellency.

The composition and cured material are useful as the coating, filler, film, sealant, and water treatment applications. The composition and cured material may be readily incorporated onto or into the substrate of the manufactured article. The substrate may be or comprise a cellulosic material such as paper, a textile, or wood. The substrate may comprise a fiber, textile, particle, board, sheet, or any combination of two or more thereof. The combination may be a textile comprising one or more fibers, a board comprising a composite of a plurality of particles (e.g., wooden particle board), or a laminate comprising two or more laminated sheets. The manufactured article may be an automotive component (e.g., seat upholstery or floor covering), a building component (e.g., exterior wood shingle or underlayment, awning, tarpaulin, tent, indoor flooring material, door, molding, or window frame), or a textile (e.g., carpet, clothing, fabric, linens, rugs, towels, or wallpaper). Alternatively, the article may define a cavity and the composition or cured material may comprise a filler material that may at least partially fill the cavity. The article may be made by applying an effective amount (e.g., water-repelling effective amount) of the composition to at least an exterior or interior surface portion of the substrate by any suitable means such as by brushing, calendaring, dipping, drawing down, (co)extruding, injection, rolling, spraying, or wiping, to give the article having the composition applied therein or thereon.

In their application to textiles to give a water repellent textile, the ingredients (A) and (B) of the composition may be added to water (ingredient (D)) in different concentrations, either at the same time or separately. The resulting composition may be applied to the textile before or after it is made into final form (e.g., as a carpet, garment, towel, rug, or wallpaper). The application to the textile may be by any suitable method such as by immersion or wet pick-up in a pad application, spraying, garment spraying, garment finishing (e.g., exhaust finishing in a dry cleaning operation), or foam finishing. Typically, a sufficient amount of the composition is contacted to the textile so as to thoroughly coat surfaces of the textile for which water repellent function is desired until a wet pick-up (WPU) amount has been applied thereto and an excess amount is left over, and then a substantial portion of the excess amount is removed (e.g., by pressing between rollers or hydroextraction) from the textile to give a textile containing the WPU amount of the composition applied thereto. Then, the WPU amount of the composition is exposed to the curing conditions, which may include the unblocking conditions (e.g., heating to the unblocking temperature) when ingredient (B) comprises the blocked isocyanate. If desired, the applied composition may then be cured in or on the substrate (e.g., textile) so as to make the manufactured article (e.g., water repellent textile). When the manufactured article is used in water repelling applications the WPU amount and amount of the resulting cured material is effective for repelling water therefrom.

The invention is further illustrated by, and each composition/method may be any combinations of features and limitations of, the non-limiting examples that follow. In the examples, all silicone materials were obtained from Dow Corning Corporation unless otherwise noted. The concentrations of ingredients in the compositions/formulations of the examples are determined from the weights of ingredients added.

General Method of Examples (Ex.) 1 to 8: Mixed following ingredients:

(A)(i) an aqueous emulsion of 40 wt % cyclohexyl epoxy-functional siloxane (EFS) and a nonionic surfactant (NIS) in water (“40 wt % Epoxysilicone Emulsion”); or (A)(ii) 31 wt % of an aqueous emulsion of a hydroxyl-terminated aminoethyl/aminopropyl-silsesquioxane (siloxane comprising T units); or (A)(iii) 33 wt % of an aqueous emulsion of a hydroxyl-terminated aminoethyl/aminopropyl-silsesquioxane (siloxane comprising T units); or (A)(iv) 35 wt % of an aqueous nonionic emulsion of an (aminopropylethoxymethylsiloxy)-terminated dimethyl methylaminopropyl siloxane and a hydroxyl-terminated polydimethylsiloxane; or (A)(v) 36 wt % of an aqueous cationic emulsion of an (aminopropylethoxymethylsiloxy)-terminated dimethyl methylaminopropyl siloxane;
(B)(i) 26 wt % dispersion of PHOBOL XAN, an oxime-blocked isocyanate in water; or (B)(ii) 21 wt % of a bifunctional blocked isocyanate in water;
(C)(i) 20 wt % cure agent in water (used with ingredient (A)(i)); or (C)(ii) 0 wt % cure agent (none used with ingredients (A)(ii)/(iii)/(v)); or (C)(iii) 0.2 wt % cure agent (used with ingredient (A)(iv);
(D)(i) Water—added enough to give 100 g of composition total weight; and
(E)(i) Surfactant: polyoxyethylene lauryl ether; or (E)(ii) Surfactant: hexadecyltrimethylammonium chloride and polyoxyethylene (12) tridecylether; or (E)(iii) Surfactant: trimethyltallowalkylammonium chloride and ethoxylated linear alcohols; so as to give the composition shown in Table 1 below.

TABLE 1
Concentration of ingredients (A) to (D) in compositions

| | Ingredients and Concentrations, wt % | | | | |
|---|---|---|---|---|---|
| | (A)(i) Epoxy | (B)(i) Oxime | | (D) | |
| | Functional | blocked | (C)(i) | H₂O | (E) |
| Ex. | siloxane/ | isocyanate | Cure agent/ | (approx. | Surfactant/ |
| No. | (wt %*) | (wt %) | (wt %) | wt %) | (wt %) |
| 1 | Epoxy/3.7 | 0.52 | NH₄H₂PO₄/0.8 | 94 | (E)(i)/0.24 |
| 2 | Epoxy/1.6 | 0.65 | NH₄H₂PO₄/0.4 | 96 | (E)(i)/0.1 |
| 3 | Epoxy/2.4 | 0.65 | NH₄H₂PO₄/0.4 | 95 | (E)(i)/0.1 |
| 4 | Epoxy/1.6 | 0.4 | Citric Acid/0.2 | 97 | (E)(i)/0.1 |

| | (A)(ii)-(v) | (B)(i) | | | |
|---|---|---|---|---|---|
| | Amino | bifunctional | | (D) | |
| | Functional | blocked | (C)(ii)-(iii) | H₂O | (E) |
| Ex. | siloxane/ | isocyanate | Cure agent/ | (approx. | Surfactant/ |
| No. | (wt %) | (wt %) | (wt %) | wt %) | (wt %) |
| 5 | (A)(ii) | 0.21 | (C)(ii) none/0 | 94.5 | (E)(ii)/0.21 |
| | Amino/4.5 | | | | |
| 6 | (A)(iii) | 0.21 | (C)(ii) none/0 | 94.7 | (E)(ii)/0.4 |
| | Amino/4,3 | | | | |
| 7 | (A)(iv) | 0.23 | (C)(iii) | 94.6 | (E)(iii)/0.1 |
| | Amino/4.0 | | CH₃CO₂H/0.2 | | |
| 8 | (A)(v) | 0.21 | (C)(ii) none/0 | 95.1 | (E)(iii)/0.3 |
| | Amino/3.9 | | | | |

*concentration of the functional siloxane in composition = wt % concentration of ingredient
(A) times concentration of ingredient (A) respectively used in Ex. 1-8:
Ex. 1, 9.3 wt % of (A)(i);
Ex. 2, 4 wt % of (A)(i);
Ex. 3, 6 wt % of (A)(i);
Ex. 4, 4 wt % of (A)(i);
Ex. 5, 15 wt % of A)(ii);
Ex. 6, 13 wt % of (A)(iii);
Ex. 7, 11.5 wt % of (A)(iv); and
Ex. 8, 11 wt % of (A)(v).

The compositions summarized in Table 1 comprise ingredients (A) to (C); water as ingredient (D); and a small amount of nonionic surfactant (ingredient (E)). The compositions may be used promptly to treat the substrate, or the compositions may be stored and then used.

Ex. 1a, 2a to 2d, 3a to 3d, 4a and 4b, 5a and 5b, 6a and 6b, 7a and 7b, 8a and 8b: preparation of water repellent (WR) textiles: In separate experiments, applied each of the compositions of Ex. 1 to 8 to a test textile by padding at a percent wet pick up (WPU), wherein the test textile was at least one of: Navy Cotton Twill (NCT) having 82% WPU; Cotton Twill I (CT-I, weight 7.56 ounces per square yard; 256 grams per square meter (g/m²)) having 82% WPU; Cotton Twill II (CT-II, weight 7.58 ounces per square yard; 257 g/m²) having 72% WPU; Navy Cotton Knit (NCK, weight 6.09 ounces per square yard; 207 g/m²) having 100% WPU; Red Polyester Knit (RPK, weight 4.07 ounces per square yard; 138 g/m²) having 137% WPU; Khaki Cotton Twill (KCT) having 72% WPU; and white (bleached) cotton woven (WCW) having 85% WPU. Then dried and cured the applied composition in a tenter frame for 2 minutes at an unblocking temperature (R^{e1}. T) to give the water repellent textiles. Recorded the weight % of cured material operatively disposed on the water repellent textiles. Tested the water repellent textiles for water repellency initially (0X) and after X (1, 5, 10, 15, 20, 25, 30, and, optionally, 35) Home Laundering-Tumble Dry (HL-TD) Cycles to give a Spray Rating (SR) according to AATCC-22-2010 spray test. Details and results are shown below in Table 2.

TABLE 2
Water Repellency Test Results

| Compos. | | | WR | | | | | | | | | |
|---|---|---|---|---|---|---|---|---|---|---|---|---|
| Ex. | Rel. | Test | Textile | Spray Rating after X number of HL-TD Cycles | | | | | | | | |
| No. | T (° C.) | Textile | Ex. No. | 0X | 1X | 5X | 10X | 15X | 20X | 25X | 30X | 35X |
| 1 | 170 | NCT | 1a | 100 | N/T | 100 | 95 | 90 | 90 | N/T | 85 | N/T |
| 2 | 160 | CT-I | 2a | 95 | 100 | 98 | 90 | 85 | 75 | 75 | 75 | N/T |
| 2 | 160 | CT-II | 2b | 100 | 100 | 98 | 90 | 85 | 85 | 80 | 75 | N/T |
| 2 | 160 | NCK | 2c | 100 | 100 | 90 | 85 | 70 | 50 | 50 | 50 | N/T |
| 2 | 160 | RPK | 2d | 100 | 100 | 98 | 90 | 85 | 85 | 85 | 85 | N/T |
| 3 | 160 | CT-I | 3a | 100 | 100 | 98 | 98 | 85 | 80 | 80 | 75 | N/T |
| 3 | 160 | CT-II | 3b | 100 | 98 | 90 | 90 | 85 | 85 | 80 | 80 | N/T |
| 3 | 160 | NCK | 3c | 100 | 100 | 98 | 85 | 70 | 50 | 50 | 50 | N/T |
| 3 | 160 | RPK | 3d | 100 | 100 | 98 | 90 | 90 | 90 | 75 | 75 | N/T |
| 4 | 160 | KCT | 4a | 100 | N/T | 90 | 95-100 | N/T | 90 | N/T | 80 | N/T |
| 4 | 160 | WCW | 4b | 100 | N/T | 90 | 90 | N/T | 90 | N/T | 80 | N/T |
| 5 | 160 | KCT | 5a | 87 | N/T | 95 | 87 | N/T | 87 | 85 | 85 | 78 |
| 5 | 160 | WCW | 5b | 97 | N/T | 97 | 92 | N/T | 78 | 87 | 60 | 70 |
| 6 | 160 | KCT | 6a | 97 | N/T | 95 | 87 | N/T | 85 | 85 | 87 | 85 |
| 6 | 160 | WCW | 6b | 100 | N/T | 97 | 97 | N/T | 92 | 87 | 80 | 80 |
| 7 | 160 | KCT | 7a | 85 | N/T | 87 | 87 | N/T | 82 | 78 | 75 | 70 |
| 7 | 160 | WCW | 7b | 90 | N/T | 70 | 92 | N/T | 85 | 50 | 67 | 68 |
| 8 | 160 | KCT | 8a | 78 | N/T | 87 | 90 | N/T | 87 | 78 | 78 | 70 |
| 8 | 160 | WCW | 8b | 55 | N/T | 60 | 82 | N/T | 72 | 50 | 55 | 65 |

In Table 2, N/T = not tested. The compositions of Examples 1-8 show effective initial water repellency (0X) on a variety of cotton and other fabrics. The water repellency was durable, maintaining a Spray Rating of at least 50, and typically at least 70 after 30 HL-TD Cycles. The durability of the Spray Ratings of the cured materials of the WR textiles is surprising since the compositions and cured materials lack a fluorocarbon.

As shown by the Examples and data in Tables 1 and 2, the composition may be cured to give the cured material. The composition may be disposed and cured on the substrate, thereby giving the manufactured article. The cured material durably repels water. The manufactured article is therefore useful, inter alia, as the water repellent coating, film, filler, sealant, or other water repellent treatment.

To illustrate the unexpected durability of the present water repellency, two non-invention comparative compositions CE1 and CE2 were made and tested. The comparative compositions were identical to, and prepared the same way as, the compositions of Examples 1 or 2, respectively, except that the comparative compositions lacked the ingredient (B) (the oxime-blocked isocyanate). CE1 was used to prepare a water repellent textile in a same manner as described for Example 1a and similarly CE2 in a same manner as described for Examples 2a-2d. Results are shown below in Table 3.

TABLE 3
Water Repellency Test Results for Non-Invention Comparative Examples

| Compar. | | | WR | | | | | | | | |
|---|---|---|---|---|---|---|---|---|---|---|---|
| Ex. | Rel. | Test | Textile | Spray Rating after X number of HL-TD Cycles | | | | | | | |
| No. | T (° C.) | Textile | Ex. No. | 0X | 1X | 5X | 10X | 15X | 20X | 25X | 30X |
| CE1 | 170 | NCT | CE1a | 100 | N/T | 100 | 85 | 80 | 80 | N/T | 80 |
| CE2 | 160 | CT-I | CE2a | 100 | 98 | 98 | 85 | 75 | 75 | 60 | 50 |
| CE2 | 160 | CT-II | CE2b | 100 | 98 | 98 | 90 | 85 | 75 | 60 | 60 |
| CE2 | 160 | NCK | CE2c | 100 | 98 | 85 | 60 | 60 | 0 | 0 | 0 |
| CE2 | 160 | RPK | CE2d | 100 | 100 | 98 | 85 | 60 | 60 | 60 | 60 |

Comparing Table 3 to Table 2 the durability of water repellency of the treated textiles of the comparative examples was significantly less than durability of water repellency of the treated textiles prepared from corresponding Examples. In some cases after just 10 HL-TD Cycles, or 15 HL-TD Cycles, and in all cases after 30 HL-TD Cycles, the Spray Ratings of the comparative examples CE1a, CE2a, CE2b, and CE2d (CE2c was undetermined after 30 HL-TD Cycles) were lower than the respective Spray Ratings of the Examples 1a and 2a, 2b, and 2d. Put another way, the durability of water repellency of the treated textiles of Examples 1a and 2a, 2b, and 2d were 6%, 50%, 25%, and 42% higher, respectively, than those of CE1a and CE2a, 2b, and 2d after 30 HL-TD Cycles. Ingredient (B) of the invention composition surprisingly and unpredictably enhances the water repellency function, including durability thereof, of the ingredient (A) and cured material prepared therefrom.

As used herein, “may” confers a choice, not an imperative. “Optionally” means is absent, alternatively is present. “Operative contact” comprises functionally effective touching, e.g., as for coating, filling, sealing, or water repelling. All “wt %” (weight percent) are, unless otherwise noted, based on total weight of all ingredients used to make the composition, which adds up to 100 wt %. “Treated” is non-covalent or covalent bonding, or any combination thereof. “Enhancing” water repellency includes increasing degree or duration of water repellent function (e.g., Spray Rating). “Curable amount” is a quantity sufficient for producing the cured material. All viscosities are conducted at 25° C. unless otherwise noted.

1. A curable siloxane composition comprising a mixture of ingredients (A) and (B):
(A) a curable amount of a reactive group-functional siloxane, which has on average per molecule at least one curing-reactive group (CRG); and
(B) an effective amount of an isocyanate or an isocyanate donor agent;
wherein the isocyanate has an average of at least one —N═C═O moiety per molecule thereof; and
wherein the isocyanate donor agent produces an isocyanate when the isocyanate donor agent is exposed to a triggering condition.

2. The composition of claim 1, wherein ingredient (B) is the isocyanate donor agent and the isocyanate donor agent is a blocked isocyanate compound of formula (B): (R^{B}—C(O)NH)_{X}R^{X} (B), wherein x is an integer of at least 1; R^{X} is a monoradical or polyradical of an aliphatic compound, wherein there are x radicals in the polyradical; and R^{B} is a releasable blocking group such that when the isocyanate donor agent is exposed to the triggering condition, the isocyanate donor agent formally produces the isocyanate as a compound of formula (I): (O═C═N)_{X}R^{X} (I) and a blocking compound of formula R^{B}—H, wherein x, R^{X}, and R^{B} are as defined above.

3. The composition of claim 2, wherein the releasable blocking group RB is (a), (b), (c), or (d):
(a) an N- or O-monoradical of a lactam;
(b) an N-monoradical of a ring N(H)-containing heteroarene;
(c) a monoradical of an oxime of formula (O): H—O—N═CR¹R² (O), wherein R¹ is hydrocarbyl, heterohydrocarbyl, or organoheteryl and R² is H, hydrocarbyl, heterohydrocarbyl, or organoheteryl; or wherein R¹ and R² are taken together to form a hydrocarbylene, heterohydrocarbylene, or organoheterylene; or
(d) any combination of at least two of (a) to (c).

4. The composition of claim 3, wherein:
(a) the lactam is ε-caprolactam, δ-valerolactam, γ-butyrolactam, or a mixture thereof;
(b) the ring N(H)-containing heteroarene is a pyrrole; a pyrazole; an imidazole; a triazole; a tetrazole, or a mixture of at least two thereof; and
(c) each of R¹ and R² independently is alkyl, cycloalkyl, or phenyl; or R¹ and R² are taken together to form an alkylene.

5. The composition of claim 1, wherein the reactive group-functional siloxane is an epoxy-functional siloxane, a hydroxyl-functional siloxane, a Si(alkyl,H)-functional siloxane, or a combination of the hydroxyl-functional siloxane and either the epoxy-functional or Si(alkyl,H)-functional siloxane; and the composition further comprises ingredient (C) a curing effective amount of a cure agent that is effective for facilitating curing of ingredient (A) under the curing conditions.

6. The composition of claim 5, wherein the reactive group-functional siloxane is the epoxy-functional siloxane, and the epoxy-functional siloxane has an average of at least one oxiranyl moiety per molecule thereof; and wherein the cure agent is a protic acid.

7. The composition of claim 6, wherein the protic acid is a dihydrogenphosphate monobasic salt or a (C₁-C₆)carboxylic acid.

8. The composition of claim 1, further comprising ingredient (D) a dispersing effective amount of a dispersing vehicle suitable for ingredients (A) and (B), wherein the dispersing vehicle is water.

9. The composition of claim 5, further comprising ingredient (D) a dispersing effective amount of a dispersing vehicle suitable for ingredients (A) and (B), wherein the dispersing vehicle is water and further comprising ingredient (E) an emulsifying effective amount of a surfactant for emulsifying the epoxy-functional siloxane in water.

10. The composition of claim 9, wherein ingredient (A) is from 1 to 99 wt %, ingredient (B) is from 1 to 99 wt %, ingredient (C) is from 0.5 to 20 wt %, ingredient (D) is from 1 to 99.9 wt %, and ingredient (E) is from 0.1 to 15 wt %, and the sum of the concentrations of ingredients (A) to (E) is at most 100 wt %.

11. The composition of claim 1, further comprising ingredient (D) a dispersing effective amount of a dispersing vehicle suitable for ingredients (A) and (B), wherein the dispersing vehicle is an aprotic organic vehicle and ingredient (B) is the isocyanate.

12. The composition of claim 1, wherein the reactive group-functional siloxane is an amino-functional siloxane, or an amino-functional silsesquioxane.

13. A method of making a curable siloxane composition comprising a mixture of ingredients (A) and (B):
(A) a curable amount of a reactive group-functional siloxane, which has on average per molecule at least one curing-reactive group (CRG); and
(B) an effective amount of an isocyanate or an isocyanate donor agent;
wherein the isocyanate has an average of at least one —N═C═O moiety per molecule thereof; and
wherein the isocyanate donor agent produces an isocyanate when the isocyanate donor agent is exposed to a triggering condition;
the method comprising:
combining ingredients (A) and (B) together under conditions effective to make the composition.

14. The method of claim 13, wherein at least one of ingredients (A) and (B) is a solid, and wherein the combining comprises mixing a suspension or melt of ingredients (A) and (B), wherein when ingredient (B) comprises the isocyanate donor agent and the isocyanate donor agent can be triggered to generate the isocyanate by heating the isocyanate donor agent at a trigger temperature, the temperature of the melt during the mixing is less than the trigger temperature.

15. The method of claim 14, wherein the curable siloxane composition comprises a mixture of ingredients (A) to (E): wherein ingredient (C) is a curing effective amount of a cure agent that is effective for facilitating curing of ingredient (A) under the curing conditions; ingredient (D) is a dispersing effective amount of a dispersing vehicle suitable for use with ingredients (A) and (B); and ingredient (E) is an emulsifying effective amount of a surfactant; and wherein ingredient (B) is the isocyanate donor agent and the dispersing vehicle is water; and the combining comprises preparing an emulsion of ingredient (A), a portion of the water of ingredient (D), and ingredient (E); preparing a dispersion of ingredient (B) in another portion of the water of ingredient (D); and mixing the emulsion and the dispersion together so as to give the mixture of ingredients (A) to (E).

16. A cured material prepared by curing the composition of claim 1.

17. A manufactured article comprising a substrate and a water-repelling effective amount of the cured material of claim 16 in operative contact therewith.

18. The manufactured article of claim 17, wherein the substrate comprises a cellulosic material and the composition comprises a water repellent coating, film, or sealant.

19. The manufactured article of claim 17, comprising a water repellent fabric wherein the substrate comprises a cotton fiber.

20. The manufactured article of claim 19, wherein the water repellent fabric has a water repellency spray rating after 30 cycles that is at least 5 percent higher than a water repellency spray rating after 30 cycles for a comparative cured material prepared from a composition comprising ingredients (A) and (C) and lacking ingredient (B), wherein each water repellency spray rating is measured according to AATCC Test Method 22-2010.
